(19) United States
(12) Patent Application Publication
(10) Pub. No.: US 2024/0284870 A1
(43) Pub. Date: Aug. 29, 2024

(54) AUTOMATIC STABLE FEEDER

(71) Applicant: Jigs and Company LLC, Medina, OH (US)

(72) Inventors: Amanda Rae GETTO, Medina, OH (US); Clayton Dailey SOLMEN, Medina, OH (US)

(21) Appl. No.: 18/175,193

(22) Filed: Feb. 27, 2023

(51) Int. Cl. A01K 5/02

(52) U.S. Cl. CPC A01K 5/0291

(57) ABSTRACT

An automatic feeder that includes a housing and a divider. The housing includes a housing exterior and a housing interior. The divider includes a base portion and a dividing portion. The dividing portion of the divider separates the housing interior into at least wo separate chambers, and the base portion separates the bottom opening into at least two separate outlets. At least two hatch doors are disposed on the base portion of the divider to cover the at least two separate outlets. The divider includes at least two electronic locks which releasably secure the at least two hatch doors in a closed position. A programmable electronic controller is included in the divider and is configured to send a time dependent signal to disengage the electronic lock and release the hatch doors to an open position.

### FIELD OF INVENTION

The present invention relates to livestock care, in particular automatic feeders for livestock, namely horses.

### BACKGROUND

Free range animals always have access to a food source and will graze according to their needs. However, when these same livestock species are kept in stalls or non-pasture enclosures, they are dependent on the nutrition that is provided to them. Conventionally, when these animals are kept in stalls, they are fed on a schedule of about two to three times a day, rather than having constant access to food. Research has shown that the two to three times a day feeding schedule is not adequate for large livestock, in particular horses.

Research has shown that horses will not go more than four hours without eating when given access to a constant food source. Under conventional feeding schedules, many horses have gaps in feedings that can range from five to fourteen hours. These delayed feedings have been shown to cause major health behavioral issues in horses such as gastric ulcers, equine metabolic syndrome, Cushing's disease, and other ailments and conditions. It is also not advantageous to leave large amounts of hay in stables for several reasons. Stables can be dark and damp places, especially in summer, large mounds of hay can go bad, mold, or be exposed to contaminants.

### SUMMARY OF THE INVENTION

Therefore, there is a need for a feeder that can accommodate the frequent feeding schedule that horses and other large livestock need to thrive but is also equipped to keep the hay or other feed fresh and protected from exposure. Furthermore, current automated livestock feeders are very large, typically used for outdoor usage, and are not practical for stable use. There is a need for an automatic feeder that is practical for stable use and can accommodate the feeding schedule that large livestock such as horses need to live. The present invention addresses these needs and others.

The present disclosure relates to an automatic feeder for use with livestock that are housed in stables, primarily horses. In accordance with an embodiment, the automatic feeder that includes a housing and a divider. The housing includes a housing exterior and a housing interior. The divider includes a base portion and a dividing portion. The dividing portion of the divider separates the housing interior into at least two separate chambers, and the base portion separates the bottom opening into at least two separate outlets. At least two hatch doors are disposed on the base portion of the divider to cover the at least two separate outlets. The divider includes at least two electronic locks which releasably secure the at least two hatch doors in a closed position. A programmable electronic controller is included in the divider and is configured to send a time dependent signal to disengage the electronic lock and release the hatch doors to an open position.

According to an aspect, an automatic feeder comprising a housing defining a housing interior; the housing includes a front opening and a bottom opening into the housing interior; a divider including a base portion and a dividing portion, wherein the dividing portion separates the housing interior into at least two separate chambers, and the base portion separates the bottom opening into at least two separate outlets; at least two hatch doors disposed on the base portion of the divider to cover the at least two separate outlets; the divider has an electric lock which releasably secures the hatch doors in a closed position; and a programmable electronic controller disposed in the divider and configured to send a time dependent signal to disengage the electronic lock and release the hatch doors to an open position.

According to an aspect, an automatic feeder for feeding stable animals comprising a housing defining a housing interior; the housing includes a first opening in a sidewall of the housing and a bottom opening in the bottom of the housing, wherein the first and second openings are into the housing interior; a divider having a base portion and a dividing portion, wherein the base portion is affixed to the housing and the dividing portion divides the housing interior into at least two separate chambers; a hinged hatch door disposed on the bottom surface of the base portion of the divider that is releasably secured in a closed position to the bottom surface of the base portion by an electronic lock; an electronic control interface for programming an electronic controller, wherein the electronic controller is configured to send a time dependent signal to disengage the electronic lock and release the hinged door to an open position; and the electronic control interface is disposed along a sidewall of the base portion.

According to an aspect, a method for feeding livestock comprising providing an automatic feeder comprising a housing defining a housing interior; the housing includes a first opening in a sidewall of the housing and a bottom opening in the bottom of the housing, wherein the first and second openings are into the housing interior; a divider having a base portion and a dividing portion, wherein the base portion is affixed to the housing and the dividing portion divides the housing interior into at least two separate chambers; a hinged hatch door disposed on the bottom surface of the base portion of the divider that is releasably secured in a closed position to the bottom surface of the base portion by an electronic lock; an electronic control interface for programming an electronic controller, wherein the electronic controller is configured to send a time dependent signal to disengage the electronic lock and release the hinged door to an open position; and the electronic control interface is disposed along a sidewall of the base portion; mounting the automatic feeder to a mounting surface; filling the at least two separate chambers with a flake of hay, wherein the hay is staked vertically; and using the electronic control interface to set a feeding schedule to set at least one time when the hinged hatch door is released into an open position.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF THE DRAWINGS

FIG. 1 illustrates a front left-side perspective view of an exemplary automatic feeder.

FIG. 2 illustrates a front right-side perspective view of the automatic feeder of FIG. 1.

FIG. 3 illustrates a bottom perspective view of a housing of the automatic feeder of FIG. 1.

FIG. 4 illustrates a back perspective view of the housing of FIG. 3.

FIG. 5 illustrates a left perspective view of a divider of the automatic feeder of FIG. 1.

FIG. 6 illustrates a right perspective view of the divider FIG. 5.

FIG. 7 illustrates a bottom perspective view of the automatic feeder of FIG. 1.

FIG. 8 illustrates a bottom view of the automatic feeder of FIG. 1.

FIG. 9 illustrates a schematic view of a first automatic feeder connected to a second automatic feeder in series.

FIG. 10 illustrates a flow diagram for an exemplary method for feeding livestock.

### DETAILED DESCRIPTION

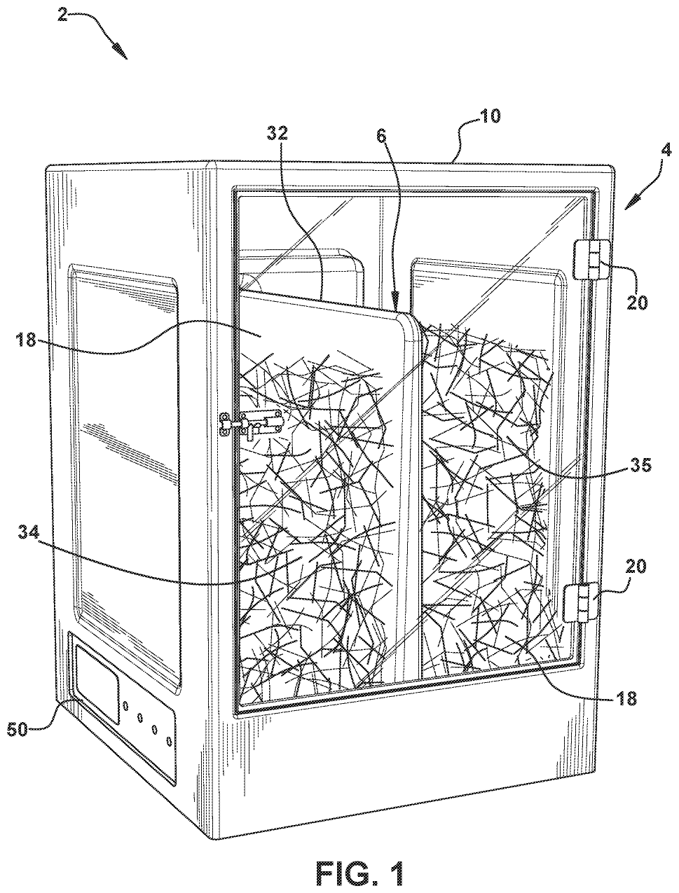

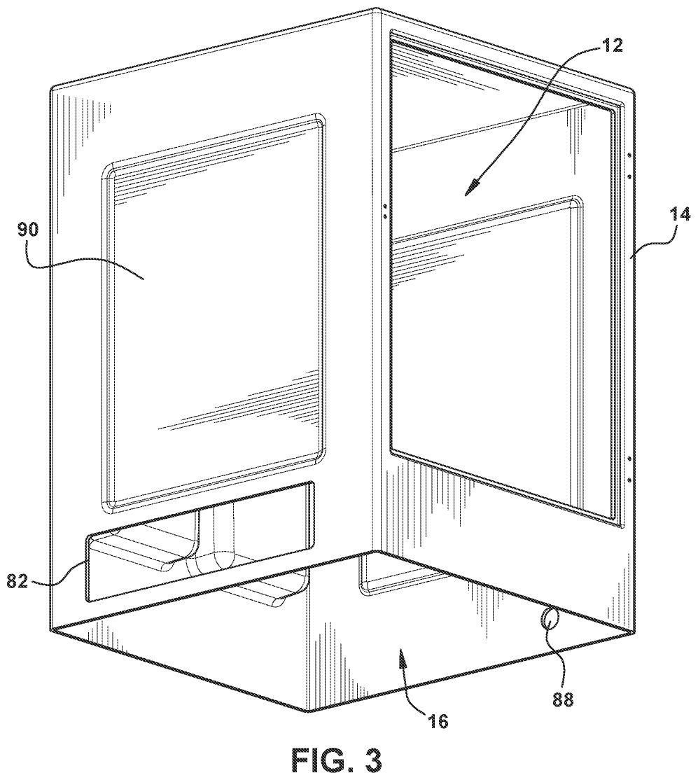

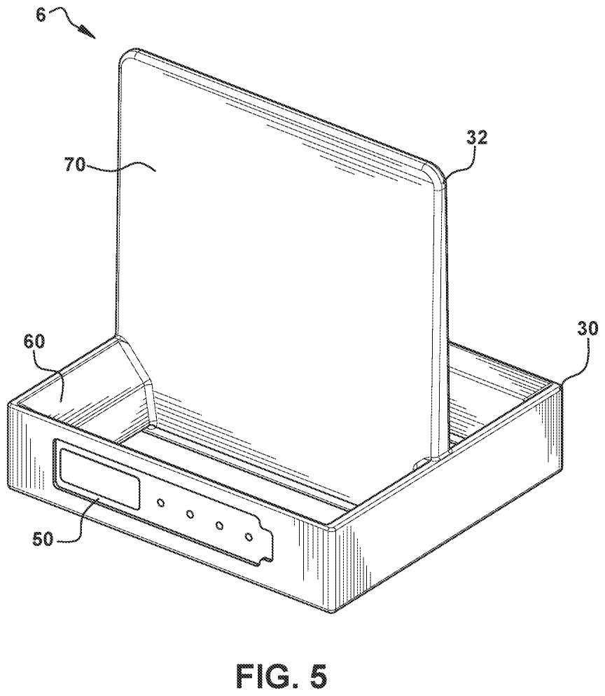

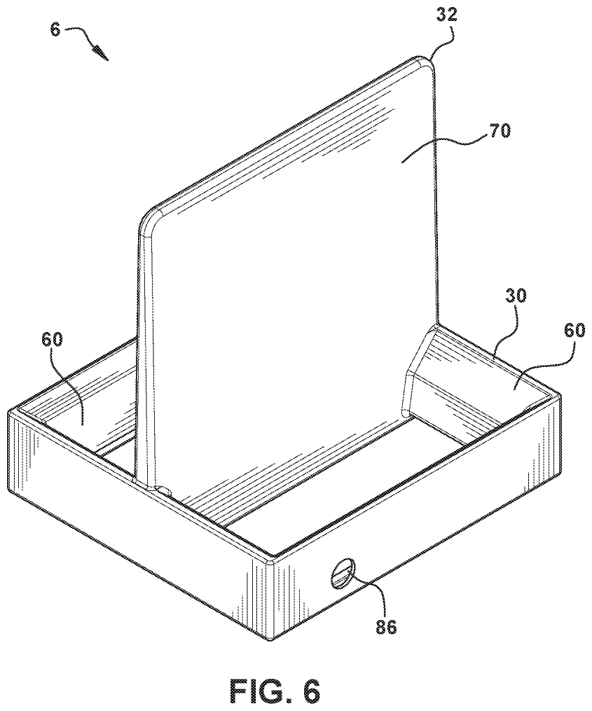

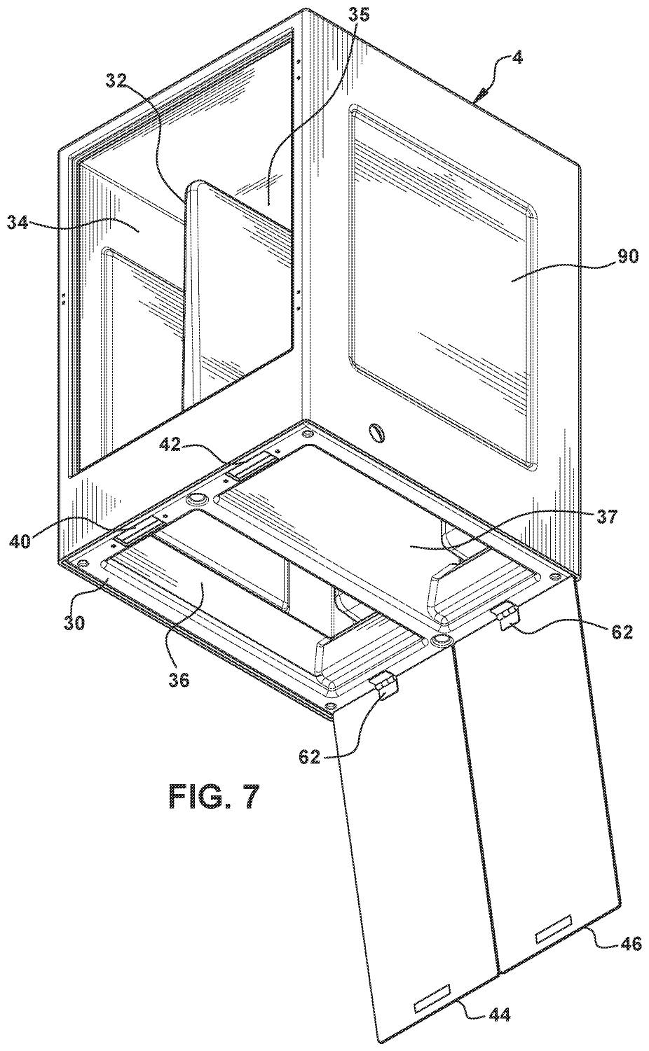

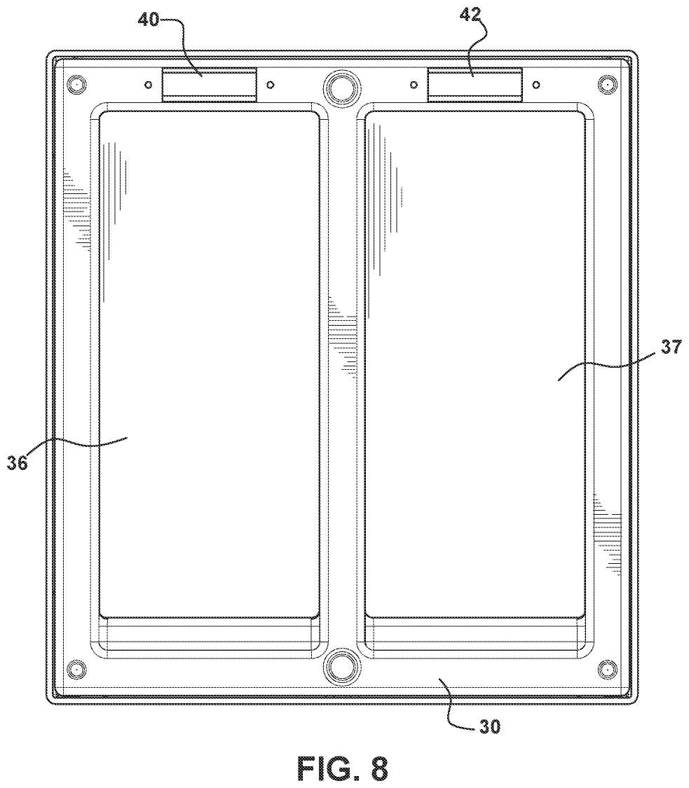

FIGS. 1-8 illustrate an exemplary automatic feeder 2 includes a housing 4 and a divider 6.

The housing 4 includes a housing exterior 10 and a housing interior 12. The housing exterior 10 is generally a rectangular prism, also known as a parallelepiped, however it is anticipated that the housing exterior 10 could be shaped in any suitable geometry. The housing 4 is hollow such that the majority of the housing 4 is the housing interior 12. The housing 4 further includes a first opening 14, which can also be referred to as a front opening 14, and a second opening 16 which can also be referred to as a bottom opening 16. The front opening 14 and the bottom opening 16 are both connected to the housing interior 12 such that the housing interior 12 may be accessed by the first and second opening 14, 16. The front opening 14 allows for a user to load a desired amount of hay into the automatic feeder 2. The housing 4 further includes an access door 18. The access door 18 is connected to the housing exterior by at least one hinge 20.

The divider 6 includes a base portion 30 and a dividing portion 32. The divider is configured such that when the divider 6 is inserted into the housing interior 12 the dividing portion 32 separates the housing interior 12 into at a first chamber 34 and a second chamber 35 for holding hay or other feed. The divider 6 is retained in the housing 4 by a fasteners, adhesives, and/or an interference fit between the divider 6 and the housing 4. The base portion 30 is rectangularly shaped with a central opening therethrough. The central opening of the base portion 30 is bisected by the dividing portion 32 into a first outlet 36 and a second outlet 37. The first chamber 34 corresponds with the first outlet 36 and the second chamber 35 corresponds with the second outlet 37 whereby the hay in chambers 34, 35 can be dispensed through the outlets 36, 37. The base portion 30 is configured to be flush with the interior surfaces of the housing 4 when the divider 6 is inserted fully into the housing interior 12. The bottom of the base portion 30 includes first and second electronic locks 40, 42 which releasably secure first and second hatch doors 44, 46, respectively, in a closed position.

The divider 6 further includes a programmable electronic controller disposed in the divider 6. The programmable electronic controller is configured to send a time dependent signal to disengage at least one of the electronic locks 40, 42 to release at least one hatch door 44, 46. The divider 6 may further have an electronic control interface 50. The electronic control interface 50 may be disposed on an outer surface of the base portion 30 of the divider. The electronic control interface 50 is connected to the programmable electronic controller, and the electronic control interface is configured to control the set length of time of the time dependent signal. The electronic control interface 50 is configured to allow an operator to set a number of options including setting the current of the day and setting unique drop times for triggering the release of the electronic locks for each individual hatch door 44, 46. The electronic control interface is also configured to allow the operator to set the duration of time the signal is sent to the electronic locks 40, 42 to ensure that the locks are fully released. The programmable electronic controller includes a real time clock that keeps track of the current time and compares the current time to the set drop times. The programmable electronic controller compares the current time to the set drop times on a repeating interval. The interval may be set as frequently as the user desires. In an exemplary embodiment the current time and set drop times are compared every 30 seconds, however the time may be shorter than 30 seconds such as 15 seconds or longer such as 1 minute. If at least one of the set drop times is greater than the current time, then the electronic programmable controller sends a signal which unlocks the specific lock 40, 42 to release the desired hatch door 44, 46.

In one embodiment, the electronic control interface 50 may be a digital interface comprising a light emitting diode (LED) display control screen with a plurality of programmable settings. The control screen may be a touch screen or have a plurality of buttons for controlling the interface. In a further embodiment, the electronic control interface 30, may be an analog control interface with a plurality of button or dials for setting a time feeding schedule. The electronic control interface 50 may be capable of storing a plurality of time settings and feeding schedules. The feeding schedules may be configured such that one of the hatch doors 44, 46 may be opened prior to the other to maintain optimal feeding times of livestock animals.

The base portion 30 of the divider 6 may further include chamfered edges 60 along the inner edge of the base portion 30. The chamfered edges 60 help funnel the hay or other feed from the chambers 34, 35 and out of the outlets 36, 37 without having the feed get stuck in the chambers 34, 35.

The hatch doors 44, 46 may be coupled to the bottom of the base portion 30 of the divider 6 by at least one hinge 62. The hinges 62 may be fastened to the hatch doors 44, 46 and the bottom of the base portion 30 of the divider 6 by adhesives or by fasteners such as screws or nuts and bolts. The hatch doors 44, 46 are configured to open when at least one of the electronic locks 40, 42 receive a time dependent signal to release and allow the hay or feed contained within the chambers 34, 35 to exit out of the exit outlets 36, 37. The electronic locks 40, 42 may be an electromagnetic lock, a bored lock, a solenoid lock, and/or a motorized lock.

The dividing portion 32 may be a vertical fin 70, which divides the housing interior 12 into the chambers 34, 35. The first and second chamber 34, 35 may be configured to fit at least one flake of hay. In a further embodiment, the dividing portion may include a plurality of vertical fins 70 which may divide the housing interior 12 into more than two chambers. The dividing portion 32 may not extend fully to the top surface of the housing interior such that the chambers 34, 35 are in fluid communication with one another. In a further embodiment, the dividing portion 32 may extend fully to the top surface of the housing interior such that the chambers 34, 35 are fully separated from one another.

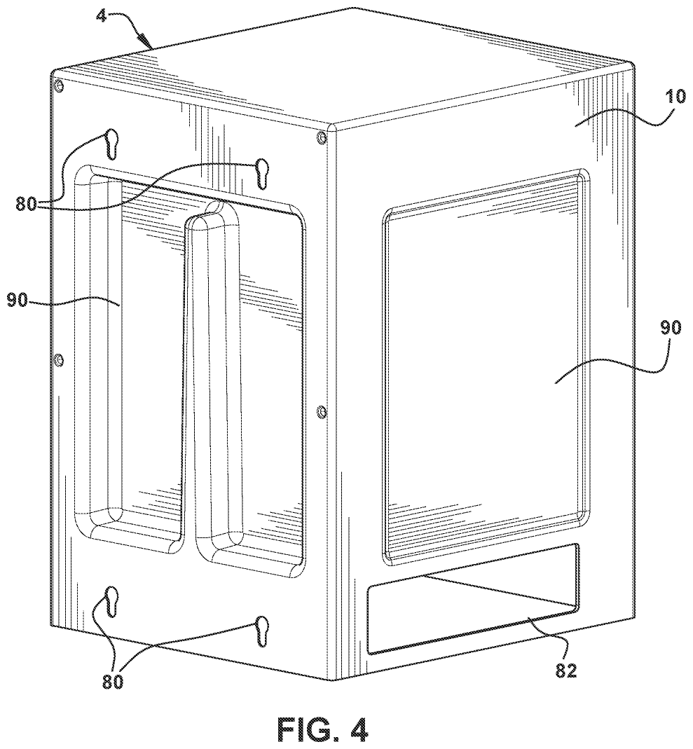

Referring now to FIG. 4, the housing 4 may have a means of mounting the automatic feeder 2 on a surface. The housing 4 may have a plurality of keyhole mounting locations 80 disposed along the back surface of the housing exterior 10. The keyhole mounting locations 80 are configured to engage a plurality of engagement features on a mounting surface such as nails, screws, and/or dowels. The depicted figure shows four keyholes 80 disposed on the back surface of the housing exterior 10, however it is anticipated that more or less keyholes may be used so long as it supports the weight of the automatic feeder 2. In a further embodiment, the housing exterior may have a means for hanging the automatic feeder 2 from a surface such as a hook that is configured to engage the edge of a stable.

The housing exterior 10 may include an interface aperture 82 which corresponds with the electronic control interface 50. The interface aperture 82 may be configured to allow access to the electronic control interface 50 through the housing exterior 10.

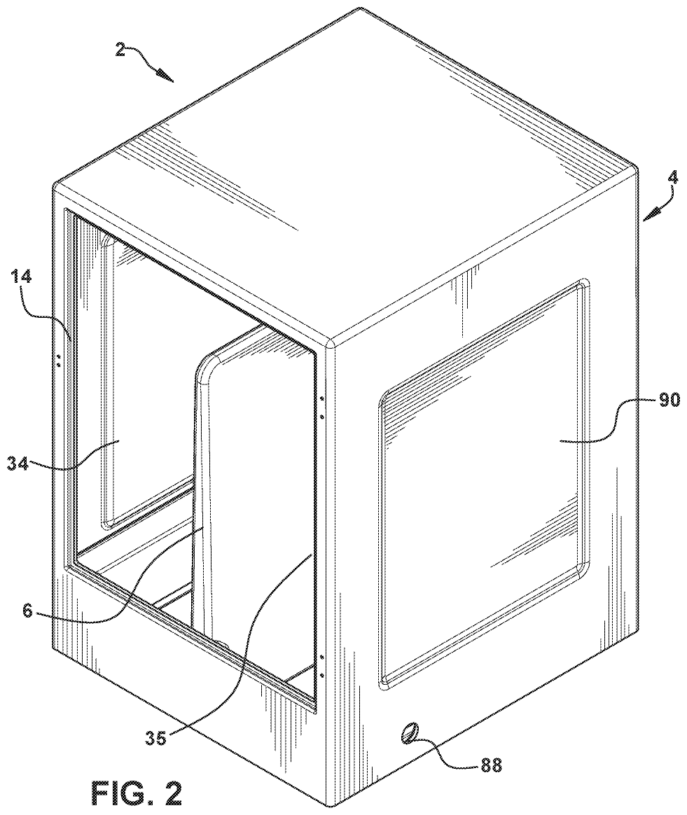

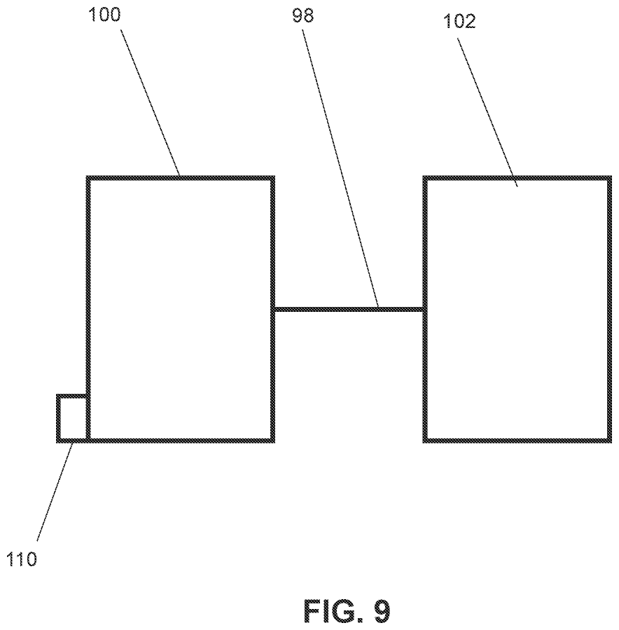

Referring now to FIG. 2 and FIG. 9, the base portion 30 of the divider 6 may include an expansion aperture 86 which corresponds with a housing expansion aperture 88 in the housing 4. The expansion aperture 86 and housing expansion aperture 88 are configured to receive a wiring harness 98 to electronically connect a first automatic feeder 100 to a second automatic feeder 102, thereby doubling the feed capacity of the entire feeding system. When the first automatic feeder 100 is electronically connected to the second automatic feeder 102, the control interface 110 of the first feeder 100 can control the feeding schedules and release of the feed from both the first and second automatic feeders 100, 102. The allows an operator to only have to use the control interface of the first automatic feeder 100 to control the release of the hatch doors of both automatic feeder 100, 102. It is to be appreciated that more than two automatic feeders can be electronically connected in series to be controlled in this manner.

The housing 4 may further include a plurality of indentations 90 in the sidewalls of the housing exterior 10. The plurality of indentations are configured to strengthen and prevent bowing of the sidewalls.

Exemplary methods may be better appreciated with reference to the flow diagram of FIG. 9. While for purposes of simplicity of explanation, the illustrated methodologies are shown and described as a series of blocks. It is to be appreciated that the methodologies are not limited by the order of the blocks, as some blocks can occur in different orders or concurrently with other blocks from that shown and described. Moreover, fewer than all the illustrated blocks may be required to implement an exemplary methodology. Furthermore, additional methodologies, alternative methodologies, or both can employ additional blocks, not illustrated.

In the flow diagrams, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagrams illustrate functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

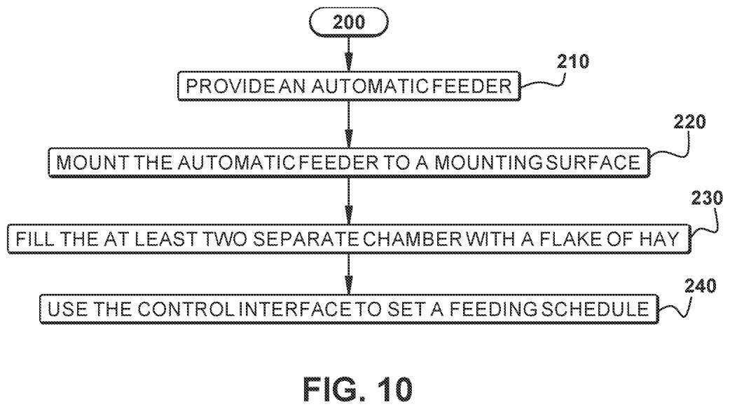

FIG. 10 illustrates a flow diagram for an exemplary method 200 for feeding livestock. At 210, the method 200 may include providing an automatic feeder.

At 220, the method 200 may include mounting the automatic feeder to a mounting surface.

At 230, the method 200 may include filling the at least two separate chambers with at least one flake of hay, wherein the hay is stacked vertically.

At 240, the method 200 may include using the electronic control interface to set a feeding schedule to set at least one time when the hinged hatch door is released into an open position.

According to an aspect, an automatic feeder comprising a housing defining a housing interior; the housing includes a front opening and a bottom opening into the housing interior; a divider including a base portion and a dividing portion, wherein the dividing portion separates the housing interior into at least two separate chambers, and the base portion separates the bottom opening into at least two separate outlets; at least two hatch doors disposed on the base portion of the divider to cover the at least two separate outlets; the divider has an electric lock which releasably secures the hatch doors in a closed position; and a programmable electronic controller disposed in the divider and configured to send a time dependent signal to disengage the electronic lock and release the hatch doors to an open position.

Embodiments may include one or more of the following additional features, separately or in any combination.

In some embodiments, the divider has an electronic control interface.

In some embodiments, the electronic control interface controls the set length of time of the time dependent signal.

In some embodiments, the electronic control interface is programmable to store multiple set lengths of time.

In some embodiments, the electronic control interface is a digital display interface.

In some embodiments, the electronic control interface is an analog control interface.

In some embodiments, the interior divider has a base portion and a dividing portion.

In some embodiments, the base portion is affixed to the housing and the dividing portion divides the housing interior into at least two separate chambers;

In some embodiments, the interior chambers are configured to hold a flake of hay.

In some embodiments, the housing includes a plurality of keyholes to interface with a corresponding plurality of fasteners to mount the automatic feeder on the wall.

In some embodiments, the housing includes a hook for engaging a stable to mount the automatic feeder.

In some embodiments, the housing has an expansion aperture for receiving a second housing to expand the automatic feeder.

In some embodiments, the bottom door is affixed to the bottom by at least one hinge.

In some embodiments, the electric lock is an electro-magnetic lock, a bored lock, a solenoid lock, or a motorized lock.

According to an aspect, an automatic feeder for feeding stable animals comprising a housing defining a housing interior; the housing includes a first opening in a sidewall of the housing and a bottom opening in the bottom of the housing, wherein the first and second openings are into the housing interior; a divider having a base portion and a dividing portion, wherein the base portion is affixed to the housing and the dividing portion divides the housing interior into at least two separate chambers; a hinged hatch door disposed on the bottom surface of the base portion of the divider that is releasably secured in a closed position to the bottom surface of the base portion by an electronic lock; an electronic control interface for programming an electronic controller, wherein the electronic controller is configured to send a time dependent signal to disengage the electronic lock and release the hinged door to an open position; and the electronic control interface is disposed along a sidewall of the base portion.

In some embodiments, the electronic control interface is programmable to store multiple set lengths of time.

In some embodiments, the electronic control interface is a digital display.

In some embodiments, the electronic lock is an electro-magnetic lock, a bored lock, a solenoid lock, or a motorized lock.

In some embodiments, the housing includes a plurality of indentations.

According to an aspect, a method for feeding livestock comprising providing an automatic feeder comprising a housing defining a housing interior; the housing includes a first opening in a sidewall of the housing and a bottom opening in the bottom of the housing, wherein the first and second openings are into the housing interior; a divider having a base portion and a dividing portion, wherein the base portion is affixed to the housing and the dividing portion divides the housing interior into at least two separate chambers; a hinged hatch door disposed on the bottom surface of the base portion of the divider that is releasably secured in a closed position to the bottom surface of the base portion by an electronic lock; an electronic control interface for programming an electronic controller, wherein the electronic controller is configured to send a time dependent signal to disengage the electronic lock and release the hinged door to an open position; and the electronic control interface is disposed along a sidewall of the base portion; mounting the automatic feeder to a mounting surface; filling the at least two separate chambers with a flake of hay, wherein the hay is staked vertically; and using the electronic control interface to set a feeding schedule to set at least one time when the hinged hatch door is released into an open position.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1. An automatic feeder comprising:
a housing defining a housing interior;
the housing includes a front opening and a bottom opening into the housing interior;
a divider including a base portion and a dividing portion, wherein the dividing portion separates the housing interior into at least two separate chambers, and the base portion separates the bottom opening into at least two separate outlets;
at least two hatch doors disposed on the base portion of the divider to cover the at least two separate outlets;
the divider has an electric lock which releasably secures the hatch doors in a closed position; and
a programmable electronic controller disposed in the divider and configured to send a time dependent signal to disengage the electronic lock and release the hatch doors to an open position.

2. The automatic feeder of claim 1, wherein the divider has an electronic control interface.

3. The automatic feeder of claim 2, wherein the electronic control interface controls the set length of time of the time dependent signal.

4. The automatic feeder of claim 3, wherein the electronic control interface is programmable to store multiple set lengths of time.

5. The automatic feeder of claim 2, wherein the electronic control interface is a digital display interface.

6. The automatic feeder of claim 2, wherein the electronic control interface is an analog control interface.

7. The automatic feeder of claim 6, wherein the interior divider has a base portion and a dividing portion.

8. The automatic feeder of claim 8, wherein the base portion is affixed to the housing and the dividing portion divides the housing interior into at least two separate chambers;

9. The automatic feeder of claim 6, wherein the interior chambers are configured to hold a flake of hay.

10. The automatic feeder of claim 1, wherein the housing includes a plurality of keyholes to interface with a corresponding plurality of fasteners to mount the automatic feeder on the wall.

11. The automatic feeder of claim 1, wherein the housing includes a hook for engaging a stable to mount the automatic feeder.

12. The automatic feeder of claim 1, wherein the housing has an expansion aperture for receiving a second housing to expand the automatic feeder.

13. The automatic feeder of claim 1, wherein the bottom door is affixed to the bottom by at least one hinge.

14. The automatic feeder of claim 1, wherein the electric lock is an electro-magnetic lock, a bored lock, a solenoid lock, or a motorized lock.

15. An automatic feeder for feeding stable animals comprising:
a housing defining a housing interior;
the housing includes a first opening in a sidewall of the housing and a bottom opening in the bottom of the housing, wherein the first and second openings are into the housing interior;
a divider having a base portion and a dividing portion, wherein the base portion is affixed to the housing and the dividing portion divides the housing interior into at least two separate chambers;
a hinged hatch door disposed on the bottom surface of the base portion of the divider that is releasably secured in a closed position to the bottom surface of the base portion by an electronic lock;
an electronic control interface for programming an electronic controller, wherein the electronic controller is configured to send a time dependent signal to disengage the electronic lock and release the hinged door to an open position; and
the electronic control interface is disposed along a sidewall of the base portion.

16. The automatic feeder of claim 15, wherein the electronic control interface is programmable to store multiple set lengths of time.

17. The automatic feeder of claim 15, wherein the electronic control interface is a digital display.

18. The automatic feeder of claim 15, wherein the electronic lock is an electro-magnetic lock, a bored lock, a solenoid lock, or a motorized lock.

19. The automatic feeder of claim 15, wherein the housing includes a plurality of indentations.

20. A method for feeding livestock comprising:
providing an automatic feeder comprising:
a housing defining a housing interior;
the housing includes a first opening in a sidewall of the housing and a bottom opening in the bottom of the housing, wherein the first and second openings are into the housing interior;
a divider having a base portion and a dividing portion,
wherein the base portion is affixed to the housing and the dividing portion divides the housing interior into at least two separate chambers;
a hinged hatch door disposed on the bottom surface of the base portion of the divider that is releasably secured in a closed position to the bottom surface of the base portion by an electronic lock;
an electronic control interface for programming an electronic controller, wherein the electronic controller is configured to send a time dependent signal to disengage the electronic lock and release the hinged door to an open position; and
the electronic control interface is disposed along a sidewall of the base portion;
mounting the automatic feeder to a mounting surface;
filling the at least two separate chambers with a flake of hay, wherein the hay is staked vertically; and
using the electronic control interface to set a feeding schedule to set at least one time when the hinged hatch door is released into an open position.
